(19) United States
(12) Patent Application Publication
(10) Pub. No.: US 2009/0113712 A1
(43) Pub. Date: May 7, 2009

(54) Modular Cryogenic Liquid Storage Systems

(75) Inventors: Stephen Joseph McKitish, Allentown, PA (US); Robert William Hadden, III, Pennsburg, PA (US); Kameel Sattouf, Allentown, PA (US); Douglas R. Williams, Allentown, PA (US); Donald Nelly, Charlotte, NC (US); Kent Richard Buzard, Matthews, NC (US); Brian Clark Jackson, SR., Sellersville, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: AIR PRODUCTS AND CHEMICALS, INC., Allentown, PA (US)

(21) Appl. No.: 12/351,513

(22) Filed: Jan. 9, 2009

Related U.S. Application Data
(62) Division of application No. 11/349,811, filed on Feb. 8, 2006.

(51) Int. Cl. B23P 15/26

(52) U.S. Cl. 29/890.035

(57) ABSTRACT

Method of designing a customer station adapted to receive a cryogenic liquid, store the cryogenic liquid, discharge the cryogenic liquid after storage, and either provide the cryogenic liquid as a liquid product to a user or vaporize the cryogenic liquid to provide a gas product to a user. The method comprises selecting design parameters including product type, range of product flow rates, and required pipe diameters and piping types. Standardized piping skids are designed for one or more of the combinations of product type, pipe size, and pipe type. The product requirements of a user are defined, the type of cryogenic liquid storage tank is determined, and a piping skid design for the required service is selected from the standardized piping skid designs. The customer station then is designed using the selected standardized piping skid design and the selected type of cryogenic storage tank.

### CROSS-REFERENCE TO RELATED APPLICATIONS

This application is a division of U.S. Ser. No. 11/349,811 filed on Feb. 8, 2006, which is wholly incorporated herein by reference.

### BACKGROUND OF THE INVENTION

Cryogenic liquids for commercial and medical applications are received, stored, and dispensed on demand by integrated tank and piping systems widely used in the industrial gas business. These well-known systems, often described as customer stations, are installed, filled, and maintained by industrial gas suppliers on customer sites. The systems typically are owned by the industrial gas suppliers and leased to the customers, although some installations are owned by the customers and serviced by the industrial gas suppliers.

The design and operating features of these systems vary widely and are determined by the type of stored cryogenic liquid, the specific form of product used by the customer (i.e., vapor or liquid), the delivery pressure, range of delivery flow rates, and other parameters specific to each customer. As a result, industrial gas suppliers typically customize these systems, particularly the piping, for each particular customer requirement.

The main components of a customer station typically include an insulated tank, piping and valve assemblies, pressure gauges, pressure buildup vaporizers, pressure relief devices, a product vaporizer (when the customer uses the product in gaseous form), a liquid pump (when the customer requires product at elevated pressure), and liquid level telemetry systems. Customer stations are installed on customer sites for receiving, storing, and delivering gases including oxygen, nitrogen, argon, and hydrogen. A customer gives specific product requirements to the supplier, and the supplier designs an appropriate customer station to meet these requirements. The supplier manages the logistics of delivering cryogenic liquid by tanker to the customer station to meet customer requirements.

Each tank in a customer station typically has a piping assembly that includes a fill connection used to connect the tank to the tanker during a fill, a full trycock valve that informs the operator when the tank is full, a telemetry unit (typically an automatic dialing system which monitors tank product level and notifies the supplier when a scheduled fill is necessary), a vent system that allows product to escape if tank pressure exceeds a maximum safe pressure, a pressure build system that permits the tank to operate at a predetermined pressure, and a product withdrawal pressure control system that provides product to the customer at the required pressure.

Each customer station may be periodically refurbished or rehabilitated by tank cleaning (exterior and interior), painting, improving structural support, replacing or upgrading thermal and/or vacuum insulation, and maintaining piping, valves, instruments, and associated components. Many industrial gas suppliers subcontract the refurbishing or rehabilitating of cryogenic storage tanks, wherein the tanks are transported to subcontractor fabrication facilities, refurbished or rehabilitated, and transported to another site for reinstallation by the industrial gas supplier. A refurbished or rehabilitated tank is seldom returned to the same customer site, and reinstallation of the tank at a new site therefore requires the installation of an individual piping assembly specific to that tank and the new site. Because an industrial gas supplier may service thousands of customer stations, the logistics of matching refurbished tanks to customer sites is complex, and this becomes a factor in the current need for customized reinstallation of refurbished or rehabilitated tanks.

There are several problems associated with this refurbishment or rehabilitation process. For every tank that is refurbished or rehabilitated, the unique piping configuration needed when the tank is reinstalled requires additional time for the design, fabrication, and installation of this piping system. While this process meets the exact customer requirements, thereby satisfying the customer, it is inefficient for the industrial gas supplier, and the added cost reduces the supplier's profit margin in the operation of that customer station.

There is a need in the industrial gas field for improvements to the customer station tank refurbishment and rehabilitation process, particularly in the design and installation of the piping systems for reinstallation of refurbished and rehabilitated tanks. This need is addressed by the embodiments of the invention described below and defined by the claims that follow.

### BRIEF SUMMARY OF THE INVENTION

An embodiment of the invention relates to a method of designing a customer station adapted to receive a cryogenic liquid, store the cryogenic liquid, discharge the cryogenic liquid after storage, and either provide the cryogenic liquid as a liquid product to a user or vaporize the cryogenic liquid to provide a gas product to a user. The method comprises:
(a) selecting design parameters including
   (a1) defining at least two product types including a first product type consisting of nitrogen, oxygen, or argon and a second product type consisting of hydrogen;
   (a2) for each of the product types of (a1) defining a first range of product flow rates and a first pipe diameter for the design of a piping skid and defining a second range of product flow rates and a second pipe diameter for the design of a piping skid;
   (a3) for each of the combinations of (a2), further defining the piping types of uninsulated copper, mechanically-insulated copper, uninsulated stainless steel, mechanically insulated stainless steel, and vacuum-jacketed stainless steel; and
   (a4) designing standardized piping skids for one or more of the combinations of (a1) and (a2) and (a3), wherein each piping skid is adapted at least to accept liquid from a cryogenic liquid tanker, transfer the liquid to a cryogenic storage tank, and provide piping to withdraw liquid from the cryogenic storage tank for distribution to the user;
(b) defining the product requirements of the user including
   (b1) a product type selected from the group consisting of oxygen, nitrogen, argon, and hydrogen;
   (b2) a product state selected from gas and liquid;
   (b3) a product flow rate or range of product flow rates; and
   (b4) a product pressure or range of product pressures;
(c) if the product state of (b2) is gas, selecting a vaporizer to vaporize the cryogenic liquid from storage;
   (d) selecting a piping skid design from (a4);
(e) selecting a type of cryogenic liquid storage tank from the group consisting of a liquefied atmospheric gas storage tank and a liquefied hydrogen storage tank; and
(f) designing the customer station comprising a selected piping skid of (d), the cryogenic storage tank of (e), and optionally the vaporizer of (c).

Each piping skid may comprise
(1) a frame;
(2) a first pipe section mounted on the frame and having a first end, a second end, and a valve disposed between the first end and the second end, wherein the first end is adapted for flow communication with the top of a cryogenic liquid storage tank;
(3) a second pipe section mounted on the frame and having a first end, a second end, and a valve disposed between the first end and the second end, wherein the first end is adapted for flow communication with the bottom of a cryogenic liquid storage tank; and
(4) a tanker fill connection in flow communication with the second end of the first pipe section and the second end of the second pipe section, wherein the tanker fill connection is adapted to receive cryogenic liquid from a cryogenic liquid tanker.

Each piping skid may comprise a third pipe section mounted on the frame and having a first end, a second end, and a valve disposed between the first and the second end, wherein the first end is adapted for flow communication with the cryogenic liquid storage tank at a predetermined liquid fill level and the second end is adapted to discharge cryogenic liquid when the valve is open and the liquid level reaches the predetermined liquid fill level during tank filling, whereby the valve serves as a liquid level trycock.

Each piping skid may comprise a third pipe section mounted on the frame and having a first end, a second end, and a valve disposed between the first and the second end, wherein the first end is adapted for flow communication with the top of cryogenic liquid storage tank and the second end is open to the atmosphere, whereby the third pipe section and valve are adapted to vent the cryogenic liquid storage tank when the valve is open.

### BRIEF DESCRIPTION OF SEVERAL VIEWS OF THE DRAWINGS

FIG. 1 is an isometric sketch of an exemplary piping skid according to an embodiment of the present invention.

FIG. 2 is piping and instrumentation diagram for the piping skid of FIG. 1.

These drawings are not necessarily to scale.

### DETAILED DESCRIPTION OF THE INVENTION

Suppliers in the industrial gas business provide product to a large number of users by transporting liquefied gas in cryogenic liquid tankers to each user site and delivering the required liquid to a customer station tank at the user site. This business model typically is described as a merchant or bulk liquid supply arrangement in which a supply contract is based on product type, usage rate, distance from the supplier's plant, product purity, and possibly other factors. Product volumes in this business model typically are larger than the volumes provided by compressed gas cylinders and smaller than the volumes provided by onsite gas generators, although exceptions to this general criterion are possible. Merchant or bulk liquid supply arrangements are used for ongoing supply, although temporary supply arrangements are sometimes used.

A customer station comprises a cryogenic liquid storage tank with associated piping and valves for transferring cryogenic liquid from a delivery tanker into the tank, withdrawing product from the tank, delivering product to the user's facility, and providing for emergency venting under upset conditions. Product may be taken by the user as a cryogenic liquid or as a gas after vaporization by a vaporizer that typically is part of the customer station. The user withdraws product at predetermined flow rates and pressures, and the supplier refills the tank as needed. The customer station is installed and maintained by the supplier, and is owned by the supplier in most cases. Occasionally, the user will own the customer station, but installation and maintenance is usually provided by the supplier.

An industrial gas company in the merchant or bulk liquid supply business may own and maintain thousands of cryogenic liquid storage tanks. These tanks typically have a long service life (on the order of decades) but require periodic refurbishment or rehabilitation that includes interior and exterior cleaning, painting, upgrading structural support, replacing or upgrading thermal insulation, and maintaining piping, valves, instruments, and associated components. Many industrial gas suppliers subcontract the refurbishing and rehabilitation of cryogenic storage tanks, wherein the tanks are transported to subcontractor fabrication facilities, refurbished or rehabilitated, and transported for reinstallation by the industrial gas supplier. When a tank is removed from a customer site for refurbishment or rehabilitation, a replacement tank may be installed immediately so that the customer can continue to receive product. Alternatively, a tank may be removed from a customer due to contract termination or because the customer's requirements change. For these and other reasons, a refurbished or rehabilitated tank is seldom returned to the same customer site, and reinstallation of the tank at a new site therefore requires the installation of an individual piping assembly specific to that tank and the new site.

The industrial gas supplier thus has a large number of tanks in different types of service. The tanks typically were manufactured by different fabricators over the years, and the age of the tanks may range from new to decades old. The nozzle locations on a given tank type are not standardized among fabricators and may vary depending on when the tank was manufactured. Thus the nozzle locations vary from tank to tank in a supplier's inventory of tanks. As a result, when a given tank is refurbished or rehabilitated and installed at a new location, piping from the tank to the user's piping system typically must be individually designed, fabricated, and installed in a customized manner. This also may be true for a new tank, since different fabricators may use different nozzle locations. The custom piping required in these situations is costly and time-consuming, and an alternative approach is desirable. The embodiments of the present invention as described below provide such an alternative approach.

In the present disclosure, a cryogenic liquid is a component having a normal boiling point below −40° F. A cryogenic liquid storage tank is an insulated tank adapted to store a cryogenic liquid at or above atmospheric pressure. A cryogenic liquid tanker is a mobile truck-based vehicle for transporting a cryogenic liquid from point of production to one or more user locations. A nozzle in a cryogenic liquid storage tank is defined as a pipe section passing from outside the tank through the insulating layer(s) to the inner tank that contains the cryogenic liquid, wherein the nozzle is welded to the inner tank and allows gas and/or liquid to enter and/or exit the tank interior. The outer end of the nozzle may have a flange or other type of fitting for connection with external piping.

The term “in flow communication with” as applied to a first and second region means that gas and/or liquid can flow from the first region to the second region and from the second region to the first region through connecting piping and/or an intermediate region. The term “connected to” as applied to a first and second region means that gas and/or liquid can flow from the first region to the second region and from the second region to the first region through connecting piping.

The term “rehabilitate” as applied to an existing cryogenic liquid storage tank includes removing all piping and attached fluid control devices on the existing tank and replacing them with new parts, thereby returning the tank to an as-new or near-new condition. The term “refurbish” as applied to an existing cryogenic liquid storage tank includes replacing only those parts that are defective or malfunctioning, thereby returning the tank to a serviceable and safely-operable condition.

The indefinite articles “a” and “an” as used herein mean one or more when applied to any feature in embodiments of the present invention described in the specification and claims. The use of “a” and “an” does not limit the meaning to a single feature unless such a limit is specifically stated. The definite article “the” preceding singular or plural nouns or noun phrases denotes a particular specified feature or particular specified features and may have a singular or plural connotation depending upon the context in which it is used. The adjective “any” means one, some, or all indiscriminately of whatever quantity. The term “and/or” placed between a first entity and a second entity means one of (1) the first entity, (2) the second entity, and (3) the first entity and the second entity.

The embodiments of the invention are directed to a modular customer station system comprising an engineered piping skid that provides a standardized interface between a cryogenic liquid storage tank, a liquid tanker delivering the cryogenic liquid, and a user of the product withdrawn from the tank. The piping skid typically includes the following characteristics:
(a) The piping and valving are fabricated and installed on a frame to provide a standardized unit that is readily installed and connected to all tanks of a particular type. The piping connections on the piping skid are located to match the piping connections on the tank, thereby simplifying the connection of the piping skid to the tank and minimizing or eliminating customized piping specific to a particular tank. The connection interface may use hard piping and fittings or flexible hose with fittings.
(b) The piping skid is independent of the tank so that the skid and tank may be shipped separately.
(c) Standardized piping skids designed for a specific tank type and defined user product requirements are interchangeable and can be used without modification in the field with any tank of the same type for the same user requirements.

The terms “pipe” and “piping” are used in the present description of the embodiments of the invention and have the usual meaning in the fluid flow art. The embodiments also may use tubes instead of pipes, and the terms “tube” and “tubing” have the usual meaning in the fluid flow art. The terms “pipe”, “piping”, “tube”, and “tubing” are interchangeable and may be used interchangeably in all embodiments of the invention.

The use of standardized piping skids will minimize the amount of piping that must be custom fabricated for each tank installation. The skid design allows both pieces of equipment (i.e., the tank and skid) to be delivered to a customer site and be connected with minimum effort. This eliminates the time associated with piping fabrication, decreases the time and cost of tank rework, simplifies troubleshooting and standard maintenance procedures for technicians in the field. It also allows changing of a tank separate from the piping skid itself. If a skid malfunctions, it can be replaced immediately with another standardized skid of the same type. If a tank malfunctions, a replacement tank can be installed without changing the standardized piping skid. Thus replacement piping skids and replacement tanks can be handled independently for a given customer location.

The use of these standardized skids with tanks having non-standard nozzle locations is an improvement over the previous need for totally customized piping systems when new or refurbished or rehabilitated tanks are installed. This approach can be improved significantly, however, if the locations of the connections on each tank are standardized to correspond to the locations of the connections on the piping skids. This may be accomplished over time during normal rehabilitation of each tank of a given type by including piping from the tank nozzles to grade with standard connection points that are located to correspond with the connection points on the piping skid. In addition, the specification for manufacturing of new tanks should include these standardized connection locations. With this approach, the inventory of tanks owned by an industrial gas supplier will become increasingly standardized for connection locations, and ideally in the limit all tanks will have standardized connection locations.

The number of standardized piping skids is defined by the number of cryogenic storage tank types, the number of types of piping required on the piping skid, and the required piping size on the piping skid as defined by product delivery flow rate.

Cryogenic storage tanks typically are designed for at least two types of product storage, the first type being designed for storage of liquefied atmospheric gases (i.e., nitrogen, oxygen, and argon) and the second type being designed for liquid hydrogen. These tank types differ in the design of the insulation system and other features, and the tanks are not readily interchangeable between gas types. Customer station storage tanks may be designed for other types of liquid cryogens (for example, carbon dioxide, helium, or liquefied light hydrocarbons), but the examples described here are designed for atmospheric gases and hydrogen. In the present examples, therefore, two types of skid designs are required—one for atmospheric gas service and one for hydrogen service. The piping designs for these skids are not identical; for example, they may incorporate different vent piping arrangements, different types of insulation, different instrument air requirements for control valve operation, and different fill connections.

In the example described below, five types of pipe may be used on the piping skids for atmospheric gases and hydrogen. Bare copper pipe or tubing typically is used for liquefied atmospheric gases when the user requires a gaseous product. In this case, insulation is not required because the liquid is vaporized in a vaporizer that is part of the customer station. Bare stainless steel pipe is used similarly when the user requires a gaseous hydrogen product. Mechanically-insulated copper pipe or stainless steel pipe (i.e., pipe surrounded by solid insulation material such as foam, perlite, or multilayer insulation) may be used for applications in which vaporization losses must be minimized. Vacuum-jacketed stainless steel pipe is used for the delivery of liquid hydrogen product to the user.

The pipe size (defined as the outside diameter of the pipe carrying the product gas or liquid) is determined by the required flow rate of the user. For example, three typical piping sizes may be specified as 1 inch, 1½ inch, and 2 inch OD. Each can handle a different range of flow rates within acceptable pressure drops.

Thus the maximum number of standardized piping skids in the above example is 15 based on two skid piping designs, three pipe sizes, two pipe types for atmospheric gas service, and three pipe types for hydrogen service. Any number of standardized skids may be defined depending on actual design requirements. A smaller number of standard skids may be defined initially, and the number may be expanded later. The number of standardized skids, whatever the number, is typically defined by the three factors described above, i.e., the number of cryogenic storage tank types, the number of types of piping required on the piping skid, and the required piping size on the piping skid as defined by product delivery flow rate.

The number of standardized skid types for the above example is summarized in the matrix of Table 1 below.

TABLE 1
Exemplary Standardized Skid Matrix

| Cryogenic | | |
|---|---|---|
| Storage Tank | Liquid Oxygen, | Liquid |
| Product | Nitrogen, or Argon | Hydrogen |
| Skid Piping | A | B |
| Design | | |
| Designation | | |
| Piping Type | Copper, bare | Stainless steel, bare |
| | Copper, mechanical | Stainless steel, |
| | insulation | mechanical insulation |
| | | Stainless steel, |
| | | vacuum jacketed |
| Piping Size | 1 inch | 1 inch |
| (OD) | 1½ inch | 1½ inch |
| | 2 inch | 2 inch |
| Total No. of | 6 | 9 |
| Configurations | | |

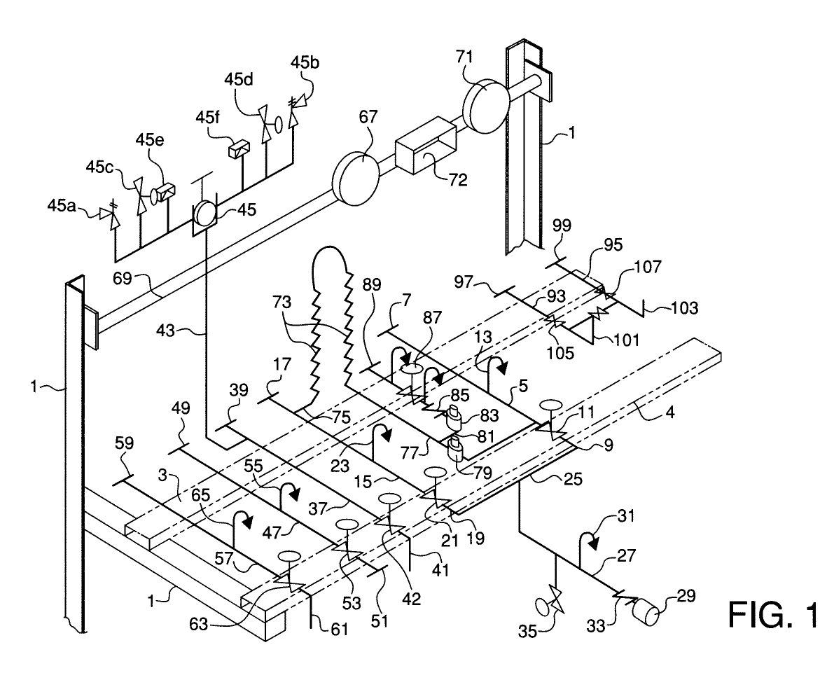

An example of a typical standardized piping skid is shown in FIG. 1. The frame is constructed of structural members 1 that may be made of stainless steel, aluminum, or painted carbon steel pipe or angle, and cross supports 3 and 4 that may be made of stainless steel, aluminum, or carbon steel channels. The pipe frame is designed to rest on the ground or preferably to be bolt-mounted on a concrete pad. A number of elements are detachably mounted on the frame and include some or all of the following components. First pipe section 5 is mounted on cross supports 3 and 4 and has rear or first end 7, front or second end 9, and valve 11 installed in the pipe section to allow or prohibit flow between the first and second ends. Thermal relief device 13 is a spring-loaded relief valve installed between first end 7 and valve 11 to vent any vapor formed if liquid becomes trapped in the line. Second pipe section 15 is mounted on cross supports 3 and 4 and has front or rear end 17, front or second end 19, and valve 21 installed in the pipe section to allow or prohibit flow between the first and second ends. Thermal relief device 23 is installed between first end 17 and valve 21.

Second or front end 9 of first pipe section 5 and second or front end 19 of second pipe section 15 are connected by manifold pipe section 25 and fill line 27 is connected to manifold pipe section 25. Fill connection 29 provides a coupling point for a delivery hose to offload cryogenic liquid from a cryogenic tanker (not shown). Fill line 27 is fitted with thermal relief device 31, check valve 33, and hose drain valve 35. First end 7 of first pipe section 5 is connected to the top end of a cryogenic liquid storage tank (not shown) located adjacent the piping skid and allows top filling of the tank with the cryogenic liquid. First end 17 of second pipe section 15 is connected to the bottom end of the cryogenic liquid storage tank and allows bottom filling of the tank with the cryogenic liquid.

In an optional embodiment, pipe section 37 is mounted on cross supports 3 and 4 and has rear or first end 39, front or second end 41, and valve 42 installed in the pipe section to allow or prohibit flow between the first and second ends. Rear or first end 39 is connected to the cryogenic liquid storage tank, typically the top of the tank, and is adapted to vent vapor from the tank manually through valve 42. Front or second end 41 is connected to the user's system when a liquid product is required by the user. Branch line 43 leads to a pressure relief tree optionally mounted on the frame to provide the safety relief function for the cryogenic liquid storage tank. This pressure relief tree comprises selector valve 45, pressure relief valves 45a and 45b, manual test valves 45c and 45d, and rupture discs 45e and 45f. Alternatively, the pressure relief tree may be mounted on the cryogenic liquid storage tank.

Fourth pipe section 47 is mounted on cross supports 3 and 4 and has rear or first end 49, front or second end 51, and valve 53 installed in the pipe section to allow or prohibit flow between the first and second ends. Thermal relief device 55 is installed between first end 49 and valve 53. Rear or first end 49 is connected to the bottom of the cryogenic liquid storage tank and allows liquid product to be withdrawn from the tank and sent to the user's system via a connection at first end 51. When the user requires a gaseous product, second end 51 is connected to a vaporizer (not shown) that converts the cryogenic liquid into a gas for delivery to the user's system.

Fifth pipe section 57 is mounted on cross supports 3 and 4 and has rear or first end 59, front or second end 61, and valve 63 installed in the pipe section to allow or prohibit flow between the first and second ends. Thermal relief device 65 is installed between first end 59 and valve 63. Rear or first end 59 is connected to the cryogenic liquid storage tank at a predetermined upper liquid fill level near the top of the tank. Valve 63 serves as a liquid level trycock during tank filling to confirm that the liquid level in the tank has reached the predetermined upper liquid fill level.

Pressure gauge 67 is mounted on upper cross support 69 and is adapted to monitor the cryogenic liquid storage tank pressure. Liquid level gauge 71 is mounted on upper cross support 69 and is adapted to indicate the liquid level in the tank at any time. Telemetry gauge 72 is mounted on upper cross support 69 and is adapted to transmit a signal proportional to the liquid level in the tank to a remote location via, for example, a dialup connection or wireless link.

Pressure build coil or vaporizer 73 is mounted on upper cross support 69 and generates gas by vaporizing a small amount of liquid from the tank, and this gas pressurizes the tank to a predetermined level. One end of pressure build coil 73 is connected via line 75 to second pipe section 15 and the other end is connected via line 77 and pressure control valve 79 to first pipe section 5. Line 81 is connected to line 77 and is in flow communication with a series of process elements including pressure control valve 83, check valve 85, and valve 87. Thermal relief devices are installed on either side of valve 87. End 89 is in flow communication with the cryogenic liquid storage tank, with a product line to the user, or with a vent to the atmosphere.

Pipe sections 93 and 95 are mounted as shown on cross support 3 and have first ends 97 and 99, second ends 101 and 103, valves 105 and 107, respectively, and thermal relief devices (not shown) on pipe sections 93 and 95. An equalizer valve is located between pipe sections 93 and 95 as shown. First end 97 is connected to a liquid tap line on the cryogenic storage tank and first end 99 is connected to a vapor tap line on the cryogenic storage tank. Second ends 101 and 103 are connected (not shown) to liquid level gauge 71.

Optionally, a pressure control manifold or a pressure and temperature control manifold may be mounted on the manifold with connections placed among the standard connections described herein. A pressure control manifold is adapted to control the pressure of product gas delivered to the user and typically includes pressure regulators, control valves, check valves, and other required components. A pressure and temperature control manifold typically includes the components of a pressure control manifold and also includes a temperature sensor and flow control component adapted to shut off gas flow if the gas temperature falls below a predetermined minimum value.

Five types of pipe may be used on the piping skids for atmospheric gases and hydrogen in the example described above. Bare copper pipe or tubing typically is used for liquefied atmospheric gases when the user requires a gaseous product. In this case, insulation is not required because the liquid is vaporized in a vaporizer that is part of the customer station. Stainless steel pipe may be used in atmospheric gas service in certain applications if desired. Bare stainless steel pipe may used when the user requires a gaseous hydrogen product. Mechanically-insulated copper pipe or stainless steel pipe may be used in certain applications. Vacuum-jacketed stainless steel pipe typically is used for the delivery of liquid hydrogen product to the user.

The pipe sizes (defined as the outside diameter of the pipe carrying the product gas or liquid) on the piping skid are determined by the required flow rates of the users. For example, three typical piping sizes may be specified as 1 inch, 1½ inch, and 2 inch OD. Each pipe size can handle a different range of flow rates within acceptable pressure drops. The skid valves may be color-coded, and frequently used valves are grouped together. A typical skid frame may have dimensions of 4 feet high, 4 feet wide, and 3 feet 5 inches deep.

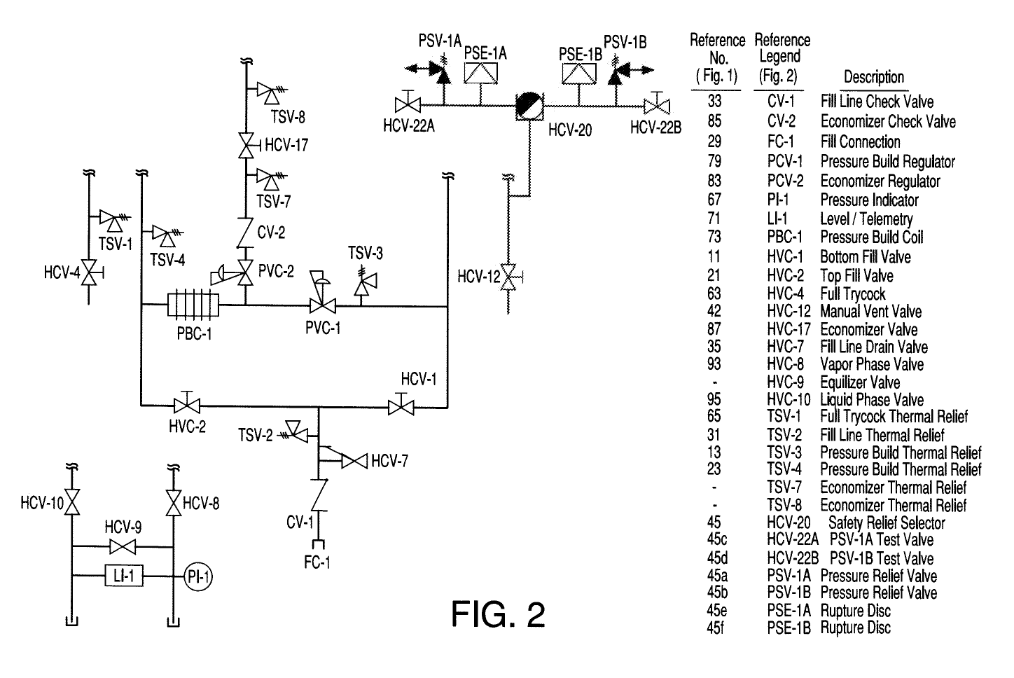

A piping and instrumentation diagram for the example piping skid of FIG. 1 is given in FIG. 2 showing the functions and process orientation of the various components and also giving the correlations with the reference numbers of FIG. 1.

The example standardized piping skid of FIG. 1 is designed such that first ends 7, 17, 39, 49, 59, 97, and 99 of pipe sections 5, 15, 37, 47, 57, 93, and 95, respectively, are located at the rear of the skid and typically are oriented in a line about 1 to 3 feet above grade or ground level and parallel to the rear of the skid as shown. Other convenient configurations of the pipe ends may be used as desired. The selected locations of these ends then are standardized to be same for each skid and are designed for easy connection to the appropriate lines on any liquid storage tank of a given type (i.e., liquid atmospheric gases or liquid hydrogen) that matches the skid type. The ends of the appropriate lines on the tank preferably have the same relative spacing and height above grade as ends 7, 17, 39, 49, 59, 97, and 99 of pipe sections 5, 15, 37, 47, 57, 93, and 95, respectively. Thus when any tank of a given type given is placed beside the proper standardized skid, each end of a pipe section on the skid will be directly adjacent the end of the appropriate pipe on the tank, and these mated ends can be readily joined by hose connections or hard piping connections as appropriate. The need for customized piping between the tank and the customer's system therefore is minimized or eliminated.

As discussed above, an industrial gas company in the merchant or bulk liquid supply business may own and maintain thousands of cryogenic liquid storage tanks. These tanks typically have a long service life (on the order of decades) but require periodic rehabilitation or refurbishment that includes interior and exterior cleaning, painting, upgrading structural support, replacing or upgrading thermal insulation, and maintaining piping, valves, instruments, and associated components. Many industrial gas suppliers subcontract the rehabilitation or refurbishing of cryogenic storage tanks, wherein the tanks are transported to subcontractor fabrication facilities, rehabilitated or refurbished, and transported for reinstallation by the industrial gas supplier. When a tank is removed from a customer site for rehabilitation or refurbishment, a replacement tank may be installed immediately so that the customer can continue to receive product. Alternatively, a tank may be removed from a customer due to contract termination or because the customer's requirements change. For these and other reasons, a rehabilitated or refurbished tank is seldom returned to the same customer site, and reinstallation of the rehabilitated or refurbished tank at a new site therefore requires the installation of an individual piping assembly specific to that tank and the new site.

The industrial gas supplier thus has a large number of tanks in different types of service. The tanks typically were manufactured by different fabricators over the years, and the age of the tanks may range from new to decades old. The nozzle locations on a given tank type are not standardized among fabricators and may vary depending on when the tank was manufactured. Thus the nozzle locations vary from tank to tank in a supplier's inventory of tanks, and this also may be true for new tanks, since different fabricators may use different nozzle locations. Standardization of the piping connection locations on the tanks in the industrial gas supplier's inventory is desirable because it reduces or eliminates the need for customized piping when installing new, rehabilitated, or refurbished tanks at new or existing user sites. This may be accomplished in embodiments of the present invention by modifying the piping connections on each tank during rehabilitation so that the connection locations are standardized and correspond to the locations of the connections on the standardized piping skids. In addition, the specification for manufacturing of new tanks should include these standardized connection locations. With this approach, the inventory of tanks owned by an industrial gas supplier will become increasingly standardized for connection locations, and ideally in the limit all tanks will have standardized connection locations that meet the connection locations on the standardized piping skids.

1. A method of designing a customer station adapted to receive a cryogenic liquid, store the cryogenic liquid, discharge the cryogenic liquid after storage, and either provide the cryogenic liquid as a liquid product to a user or vaporize the cryogenic liquid to provide a gas product to a user, which method comprises:
(a) selecting design parameters including
(a1) defining at least two product types including a first product type consisting of nitrogen, oxygen, or argon and a second product type consisting of hydrogen;
(a2) for each of the product types of (a1) defining a first range of product flow rates and a first pipe diameter for the design of a piping skid and defining a second range of product flow rates and a second pipe diameter for the design of a piping skid;
(a3) for each of the combinations of (a2), further defining the piping types of uninsulated copper, mechanically-insulated copper, uninsulated stainless steel, mechanically insulated stainless steel, and vacuum-jacketed stainless steel; and
(a4) designing standardized piping skids for one or more of the combinations of (a1) and (a2) and (a3), wherein each piping skid is adapted at least to accept liquid from a cryogenic liquid tanker, transfer the liquid to a cryogenic storage tank, and provide piping to withdraw liquid from the cryogenic storage tank for distribution to the user;
(b) defining the product requirements of the user including
(b1) a product type selected from the group consisting of oxygen, nitrogen, argon, and hydrogen;
(b2) a product state selected from gas and liquid;
(b3) a product flow rate or range of product flow rates; and
(b4) a product pressure or range of product pressures;
(c) if the product state of (b2) is gas, selecting a vaporizer to vaporize the cryogenic liquid from storage;
(d) selecting a piping skid design from (a4);
(e) selecting a type of cryogenic liquid storage tank from the group consisting of a liquefied atmospheric gas storage tank and a liquefied hydrogen storage tank; and
(f) designing the customer station comprising a selected piping skid of (d), the cryogenic storage tank of (e), and optionally the vaporizer of (c).

2. The method of claim 1 wherein each piping skid comprises
(1) a frame;
(2) a first pipe section mounted on the frame and having a first end, a second end, and a valve disposed between the first end and the second end, wherein the first end is adapted for flow communication with the top of a cryogenic liquid storage tank;
(3) a second pipe section mounted on the frame and having a first end, a second end, and a valve disposed between the first end and the second end, wherein the first end is adapted for flow communication with the bottom of a cryogenic liquid storage tank; and
(4) a tanker fill connection in flow communication with the second end of the first pipe section and the second end of the second pipe section, wherein the tanker fill connection is adapted to receive cryogenic liquid from a cryogenic liquid tanker.

3. The method of claim 2 wherein each piping skid comprises a third pipe section mounted on the frame and having a first end, a second end, and a valve disposed between the first and the second end, wherein the first end is adapted for flow communication with the cryogenic liquid storage tank at a predetermined liquid fill level and the second end is adapted to discharge cryogenic liquid when the valve is open and the liquid level reaches the predetermined liquid fill level during tank filling, whereby the valve serves as a liquid level trycock.

4. The method of claim 2 wherein each piping skid comprises a third pipe section mounted on the frame and having a first end, a second end, and a valve disposed between the first and the second end, wherein the first end is adapted for flow communication with the top of cryogenic liquid storage tank and the second end is open to the atmosphere, whereby the third pipe section and valve are adapted to vent the cryogenic liquid storage tank when the valve is open.
